(19) United States
(12) Patent Application Publication
(10) Pub. No.: US 2021/0080410 A1
(43) Pub. Date: Mar. 18, 2021

(54) CARBON FIBER WINDOW FOR X-RAY DIFFRACTOMETER

(71) Applicant: PROTO PATENTS LTD., Oldcastle (CA)

(72) Inventors: Vedran Nicholas VUKOTIC, Oldcastle (CA); Stanislav VEINBERG, Oldcastle (CA); Natan CARATASANOV, Oldcastle (CA)

(73) Assignee: PROTO PATENTS LTD., Oldcastle, ON (CA)

(21) Appl. No.: 16/975,124

(22) PCT Filed: Feb. 21, 2019
(86) PCT No.: PCT/CA2019/050211

§ 371 Date: Aug. 22, 2020

Related U.S. Application Data
(60) Provisional application No. 62/633,670, filed on Feb. 22, 2018.

(51) Int. Cl. G01N 23/20008; B32B 5/02; B32B 5/12; B32B 5/26; B32B 27/12; B32B 27/28; B32B 27/38; G01N 23/207

(52) U.S. Cl. CPC G01N 23/20008; B32B 5/024; B32B 5/12; B32B 5/26; B32B 27/12; B32B 27/281; G01N 2223/317; G01N 23/207; B32B 2260/023; B32B 2260/046; B32B 2262/106; B32B 2307/412; B32B 2551/00; B32B 27/38

(57) ABSTRACT

An X-ray window of an X-ray diffractometer diffraction chamber is provided. The X-ray window can include: a plurality of unidirectional carbon fiber sheets stacked one over another, wherein carbon fibers in adjacent carbon fiber sheets are disposed at an angle relative to one another; and a binding material that binds the plurality of unidirectional carbon fiber sheets together, the binding material being at least partially transparent to X-ray radiation. The X-ray window can also or alternatively include: at least one carbon fiber sheet, the X-ray window having a carbon fiber content of at least 50 wt % and a thickness between about 0.2 mm and about 5 mm to be adapted for use at a pressure greater than atmospheric pressure.

### CROSS-REFERENCE TO RELATED APPLICATIONS

PCT International Patent Application No. PCT/CA2019/050211 filed on Feb. 21, 2019

Priority claimed to U.S. Provisional Application Ser. No. 62/633,670 filed on Feb. 22, 2018

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### FIELD

The technical field generally relates to windows for X-ray diffractometers, and more specifically relates to carbon fiber windows for the diffraction chamber of an X-ray diffractometer.

### BACKGROUND

X-ray windows typically enclose an X-ray source, an X-ray detection chamber, or an X-ray diffraction chamber. X-ray windows can be used to separate air (or more generally the atmosphere outside the diffraction chamber or X-ray source) from a vacuum, higher pressure, or different atmosphere within the enclosure, while allowing passage of X-ray radiation.

For applications where X-ray diffraction measurements are performed at a pressure greater than atmospheric pressure, the X-ray window of an X-ray diffraction chamber is generally adapted to withstand the pressure. For example, existing beryllium-based or polymer-based X-ray windows are reinforced and/or thickened to withstand the higher pressure. However, existing solutions tend to provide X-ray windows that can contaminate the X-ray diffraction measurement.

In view of the above, many challenges still exist in the field of X-ray windows.

### SUMMARY

In one aspect, there is provided an X-ray window of an X-ray diffractometer diffraction chamber, the X-ray window including a plurality of unidirectional carbon fiber sheets stacked one over another and bound together, wherein carbon fibers in adjacent carbon fiber sheets are disposed at an angle relative to one another.

In some embodiments, the X-ray window is adapted for use at a pressure greater than atmospheric pressure.

In some embodiments, the pressure is of about 2 atm or greater.

In some embodiments, the X-ray window is adapted for use at atmospheric pressure or at a pressure lower than atmospheric pressure.

In some embodiments, the X-ray window is adapted for use under vacuum.

In some embodiments, the X-ray window has a thickness between about 0.2 mm and about 5 mm.

In some embodiments, each carbon fiber sheet has a thickness between 0.1 mm and 0.5 mm.

In some embodiments, the plurality of unidirectional carbon fiber sheets includes:
a first carbon fiber sheet including carbon fibers oriented in a first direction; and
a second carbon fiber sheet stacked over the first carbon fiber sheet, the second carbon fiber sheet including carbon fibers oriented in a second direction at an angle α₁₋₂ between about 5° and about 175° relative to the first direction.

In some embodiments, the angle α₁₋₂ is between about 30° and about 110°.

In some embodiments, the angle α₁₋₂ is between about 45° and about 90°.

In some embodiments, the plurality of unidirectional carbon fiber sheets further includes:
a third carbon fiber sheet stacked over the second carbon fiber sheet, the third carbon fiber sheet including carbon fibers oriented in a third direction at an angle α₂₋₃ between about 5° and about 175° relative to the second direction.

In some embodiments, the angle α₂₋₃ is between about 30° and about 110°.

In some embodiments, the angle α₂₋₃ is between about 45° and about 90°.

In some embodiments, each of the unidirectional carbon fiber sheets is independently oriented at an angle of about 45° or about 90° relative to adjacent unidirectional carbon fiber sheets.

In some embodiments, each of the unidirectional carbon fiber sheets is oriented at an angle of about 90° relative to adjacent unidirectional carbon fiber sheets.

In some embodiments, each of the unidirectional carbon fiber sheets is oriented at an angle of about 45° relative to adjacent unidirectional carbon fiber sheets.

In some embodiments, the X-ray window further includes a binding material that binds the plurality of unidirectional carbon fiber sheets together, the binding material being at least partially transparent to X-ray radiation.

In some embodiments, the binding material includes at least one of a thermosetting polymer and a thermoplastic polymer.

In some embodiments, the binding material includes at least one of an epoxy resin and a polyimide.

In some embodiments, the X-ray window further includes at least one layer of non-carbon fiber material that is at least partially transparent to X-ray radiation.

In some embodiments, the non-carbon fiber material includes at least one of beryllium, a polymer, diamond, graphene, diamond-like carbon, carbon nanotubes, and combinations thereof.

In some embodiments, the polymer includes a polyimide.

In some embodiments, the at least one layer of non-carbon fiber material is stacked over or under the plurality of unidirectional carbon fiber sheets.

In some embodiments, the at least one layer of non-carbon fiber material includes two layers of non-carbon fiber material sandwiching the plurality of unidirectional carbon fiber sheets.

In some embodiments, the at least one layer of non-carbon fiber material is embedded in at least one of the plurality of unidirectional carbon fiber sheets.

In some embodiments, the X-ray window attenuates 80% or less of Cu X-ray radiations.

In some embodiments, the X-ray window attenuates 40% or less of Cu X-ray radiations.

In some embodiments, the X-ray window attenuates 80% or less of Mo X-ray radiations.

In some embodiments, the X-ray window attenuates 40% or less of Mo X-ray radiations.

In some embodiments, the X-ray window has a carbon fiber content of at least 50 wt %.

In some embodiments, the X-ray window has a carbon fiber content of at least 60 wt %.

In some embodiments, the X-ray window has a carbon fiber content of at least 70 wt %.

In some embodiments, the X-ray window has a carbon fiber content between 50 wt % and 70 wt %, and a binding material content between about 50 wt % and about 30 wt %.

In some embodiments, the X-ray window has a carbon fiber content between about 50 wt % and about 70 wt %, with the remainder being the binding material.

In another aspect, there is provided an X-ray window of an X-ray diffractometer diffraction chamber, the X-ray window including at least one carbon fiber sheet, the X-ray window having a carbon fiber content of at least 50 wt % and a thickness between about 0.2 mm and about 5 mm to be adapted for use at a pressure greater than atmospheric pressure.

In some embodiments, the pressure is of about 2 atm or greater.

In some embodiments, the at least one carbon fiber sheet includes a plurality of unidirectional carbon fiber sheets stacked one over another, wherein carbon fibers in adjacent carbon fiber sheets are disposed at an angle relative to one another.

In some embodiments, the plurality of unidirectional carbon fiber sheets includes:
a first carbon fiber sheet including carbon fibers oriented in a first direction; and
a second carbon fiber sheet stacked over the first carbon fiber sheet, the second carbon fiber sheet including carbon fibers oriented in a second direction at an angle α₁₋₂ between about 5° and about 1750 relative to the first direction.

In some embodiments, the angle α₁₋₂ is between about 30° and about 110°.

In some embodiments, the angle α₁₋₂ is between about 45° and about 90°.

In some embodiments, the plurality of unidirectional carbon fiber sheets further includes:
a third carbon fiber sheet stacked over the second carbon fiber sheet, the third carbon fiber sheet including carbon fibers oriented in a third direction at an angle α₂₋₃ between about 5° and about 175° relative to the second direction.

In some embodiments, the angle α₂₋₃ is between about 30° and about 110°.

In some embodiments, the angle α₂₋₃ is between about 45° and about 90°.

In some embodiments, each of the unidirectional carbon fiber sheets is independently oriented at an angle of about 45° or about 90° relative to adjacent unidirectional carbon fiber sheets.

In some embodiments, each of the unidirectional carbon fiber sheets is oriented at an angle of about 90° relative to adjacent unidirectional carbon fiber sheets.

In some embodiments, each of the unidirectional carbon fiber sheets is oriented at an angle of about 45 relative to adjacent unidirectional carbon fiber sheets.

In some embodiments, the X-ray window further includes at least one layer of non-carbon fiber material that is at least partially transparent to X-ray radiation.

In some embodiments, the non-carbon fiber material includes at least one of beryllium, a polymer, diamond, graphene, diamond-like carbon, carbon nanotubes, and combinations thereof.

In some embodiments, the polymer includes a polyimide.

In some embodiments, the at least one layer of non-carbon fiber material is stacked over or under the plurality of unidirectional carbon fiber sheets.

In some embodiments, the at least one layer of non-carbon fiber material includes two layers of non-carbon fiber material sandwiching the plurality of unidirectional carbon fiber sheets.

In some embodiments, the at least one layer of non-carbon fiber material is embedded in at least one of the plurality of unidirectional carbon fiber sheets.

In some embodiments, the at least one carbon fiber sheet includes at least one woven carbon fiber sheet.

In some embodiments, the at least one woven carbon fiber sheet includes a twill weave.

In some embodiments, the X-ray window has a carbon fiber content of at least 60 wt %.

In some embodiments, the X-ray window has a carbon fiber content of at least 70 wt %.

In some embodiments, the X-ray window further includes a binding material that binds the plurality of unidirectional carbon fiber sheets together, the binding material being at least partially transparent to X-ray radiation.

In some embodiments, the X-ray window has a carbon fiber content between 50 wt % and 70 wt %, and a binding material content between about 50 wt % and about 30 wt %.

In some embodiments, the X-ray window has a carbon fiber content between 50 wt % and 70 wt %, with the remainder being the binding material.

In some embodiments, the binding material includes at least one of a thermosetting polymer and a thermoplastic polymer.

In some embodiments, the binding material includes at least one of an epoxy resin and a polyimide.

In some embodiments, each carbon fiber sheet has a thickness between 0.1 mm and 0.3 mm.

In some embodiments, the X-ray window has a thickness between about 0.25 mm and about 1 mm.

In some embodiments, the X-ray window has a thickness between about 0.25 mm and about 0.8 mm.

In some embodiments, the X-ray window attenuates 80% or less of Cu X-ray radiations.

In some embodiments, the X-ray window attenuates 40% or less of Cu X-ray radiations.

In some embodiments, the X-ray window attenuates 80% or less of Mo X-ray radiations.

In some embodiments, the X-ray window attenuates 40% or less of Mo X-ray radiations.

In another aspect, there is provided an X-ray window of an X-ray diffractometer diffraction chamber, the X-ray window including at least one woven carbon fiber sheet.

In some embodiments, the at least one woven carbon fiber sheet includes at least one carbon fiber twill weave.

In some embodiments, the at least one twill weave includes a plurality of carbon fiber twill weaves stacked one over another.

In some embodiments, the plurality of carbon fiber twill weaves are bound together.

In some embodiments, the X-ray window further includes a binding material that binds the plurality of unidirectional carbon fiber sheets together, the binding material being at least partially transparent to X-ray radiation.

In some embodiments, the binding material includes at least one of a thermosetting polymer and a thermoplastic polymer.

In some embodiments, the binding material includes at least one of an epoxy resin and a polyimide.

In some embodiments, the at least one twill weave is a single carbon fiber twill weave.

In some embodiments, the at least one carbon fiber twill weave includes a 2×2 carbon fiber twill weave.

In some embodiments, the X-ray window is adapted for use at a pressure greater than atmospheric pressure.

In some embodiments, the pressure is of about 2 atm or greater.

In some embodiments, the X-ray window is adapted for use at atmospheric pressure or at a pressure lower than atmospheric pressure.

In some embodiments, the X-ray window is adapted for use under vacuum.

In some embodiments, the X-ray window has a thickness between about 0.2 mm and about 5 mm.

In some embodiments, each carbon fiber sheet has a thickness between 0.1 mm and 0.5 mm.

In some embodiments, the X-ray window further includes at least one layer of non-carbon fiber material that is at least partially transparent to X-ray radiation.

In some embodiments, the non-carbon fiber material includes at least one of beryllium, a polymer, diamond, graphene, diamond-like carbon, carbon nanotubes, and combinations thereof.

In some embodiments, the polymer includes a polyimide.

In some embodiments, the at least one layer of non-carbon fiber material is stacked over or under the at least one woven carbon fiber sheet.

In some embodiments, the X-ray window attenuates 80% or less of Cu X-ray radiations.

In some embodiments, the X-ray window attenuates 40% or less of Cu X-ray radiations.

In some embodiments, the X-ray window attenuates 80% or less of Mo X-ray radiations.

In some embodiments, the X-ray window attenuates 40% or less of Mo X-ray radiations.

In some embodiments, the X-ray window has a carbon fiber content of at least 50 wt %.

In some embodiments, the X-ray window has a carbon fiber content of at least 60 wt %.

In some embodiments, the X-ray window has a carbon fiber content of at least 70 wt %.

In some embodiments, the X-ray window has a carbon fiber content between 50 wt % and 70 wt %, and a binding material content between about 50 wt % and about 30 wt %.

In some embodiments, the X-ray window has a carbon fiber content between about 50 wt % and about 70 wt %, with the remainder being the binding material.

In some embodiments, the X-ray diffractometer is a powder X-ray diffractometer.

In another aspect, there is provided a diffraction chamber of an X-ray diffractometer, including the X-ray window as defined herein.

In another aspect, there is provided an X-ray window assembly of a diffraction chamber, the X-ray window assembly including:
a support frame defining a support surface and an aperture, the support surface at least partially surrounding the aperture;
the X-ray window as defined herein, positioned over the aperture and abutted against the support surface, to pass X-ray radiation therethrough;
a securing plate positioned over at least a portion of the X-ray window such that the X-ray window is sandwiched between the securing plate and the support frame; and
a fastening assembly to secure the support frame, the X-ray window and the securing plate together.

### BRIEF DESCRIPTION OF THE DRAWINGS

FIG. 1A is a schematic cross-sectional side view of an X-ray window including two unidirectional carbon fiber sheets stacked over one another;

FIG. 1B is a schematic exploded perspective view of the X-ray window of FIG. 1A;

FIG. 2A is a schematic cross-sectional side view of an X-ray window including three unidirectional carbon fiber sheets stacked over one another;

FIG. 2B is a schematic exploded perspective view of the X-ray window of FIG. 2A;

FIG. 3 is a schematic cross-sectional side view of an X-ray window including one non-carbon fiber layer stacked over the carbon fiber sheets;

FIG. 4 is a schematic cross-sectional side view of an X-ray window including one non-carbon fiber layer upon which are stacked the carbon fiber sheets;

FIG. 5 is a schematic cross-sectional side view of an X-ray window including one non-carbon fiber layer positioned between two adjacent carbon fiber sheets;

FIG. 6 is a schematic cross-sectional side view of an X-ray window including two non-carbon fiber layers each positioned between two adjacent carbon fiber sheets;

FIG. 7 is a perspective view of an X-ray diffraction chamber including X-ray windows;

FIG. 8 is a bottom plan view of the X-ray diffraction chamber of FIG. 7;

FIG. 9 is atop plan view of the X-ray diffraction chamber of FIG. 7;

FIG. 10 is aside elevation view of the X-ray diffraction chamber of FIG. 7;

FIG. 11 is a front plan view of the X-ray diffraction chamber of FIG. 7;

FIG. 12 is a perspective view of the X-ray diffraction chamber of FIG. 7, in which a first X-ray window and a second X-ray window can be seen;

FIG. 13 is a partially exploded view of the X-ray diffraction chamber of FIG. 7, in which one X-ray window assembly is shown in exploded view;

FIG. 14 is a truncated perspective view that shows a sample holder positioned within the X-ray diffraction chamber of FIG. 7;

FIG. 15 is a graph showing the Relative diffraction peak intensity for LaB₆ as a function of window film materials when collected using Cu radiation; and

FIG. 16 is a graph showing the Relative diffraction peak intensity for LaB₆ as a function of window film materials when collected using Mo radiation.

FIG. 17 is a perspective view of an X-ray diffraction chamber including a curved X-ray window;

FIG. 18 is a top plan view of the X-ray diffraction chamber of FIG. 17;

FIG. 19 is a side elevation view of the X-ray diffraction chamber of FIG. 17; and

FIG. 20 is a partially exploded view of the X-ray diffraction chamber of FIG. 17, in which the X-ray window assembly is shown in exploded view.

### DETAILED DESCRIPTION

### X-Ray Window

The present description provides X-ray windows including at least one carbon fiber sheet. As will be further described herein, the X-ray window can include a single carbon fiber sheet, or several carbon fiber sheets stacked one over another and bound together. In some embodiments, the carbon fiber sheets can be unidirectional carbon fiber sheets. In some embodiments, the unidirectional carbon fiber sheets can be disposed at an angle relative to one another. In other embodiments, the X-ray window can include one or more woven carbon fiber sheets, such as a carbon fiber twill weave. Several non-limiting examples and features of the X-ray windows are described herein.

The X-ray window can be adapted for use at different pressures, such as atmospheric pressure, under vacuum, at a pressure lower than atmospheric pressure, or at a pressure higher than atmospheric pressure. For example, the X-ray window can be adapted for use at pressures of about 2 atm and/or greater. For example, the thickness of the X-ray window can be adjusted depending on various parameters to be able to withstand high pressure while X-ray diffraction measurements can still be performed. The X-ray window can also be adapted by covering at least a portion of the X-ray window with a securing plate to which at least a portion of the pressure forces can be transferred. In some scenarios, the thickness of the X-ray window can be between about 0.2 mm and about 5 mm, or between about 0.2 mm and about 2 mm, or between about 0.25 mm and about 2 mm, or between about 0.25 mm and 1 mm.

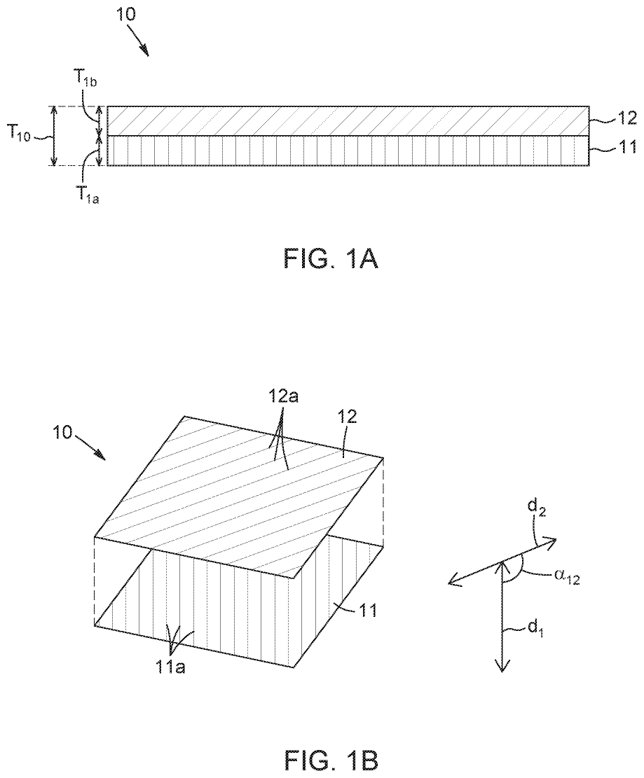

As illustrated on FIGS. 1A and 1B, an X-ray window 10 including two unidirectional carbon fiber sheets 11 and 12 is shown. Carbon fiber sheet 12 is stacked over carbon fiber sheet 11, and the carbon fiber sheets are bound together. In the cross-section view shown at FIG. 1A, carbon fiber sheets 11 and 12 have a thickness T₁ₐ and T_{1b}, respectively, that can vary. For example, the thickness of each carbon fiber sheet can be between 0.1 mm and 0.3 mm. consequently, the total thickness T₁₀ of the X-ray window 10 can also vary. For example, the thickness T₁₀ can be between about 0.2 mm and 0.6 mm. In the unstacked view shown at FIG. 1B, the carbon fiber sheets 11 and 12 are shown individually. Carbon fiber sheet 11 includes carbon fibers 11a that are oriented substantially in one direction d₁. Similarly, carbon fiber sheet 12 includes carbon fibers 12a that are oriented substantially in one direction d₂, with d₂ being at an angle α₁₂ relative to d₁. On FIG. 1B, the angle α₁₂ is of about 110°. However, it should be understood that the angle α₁₂ can vary, for example between about 5° and 175° or between about 30 and about 110°, or between about 450 and about 90°.

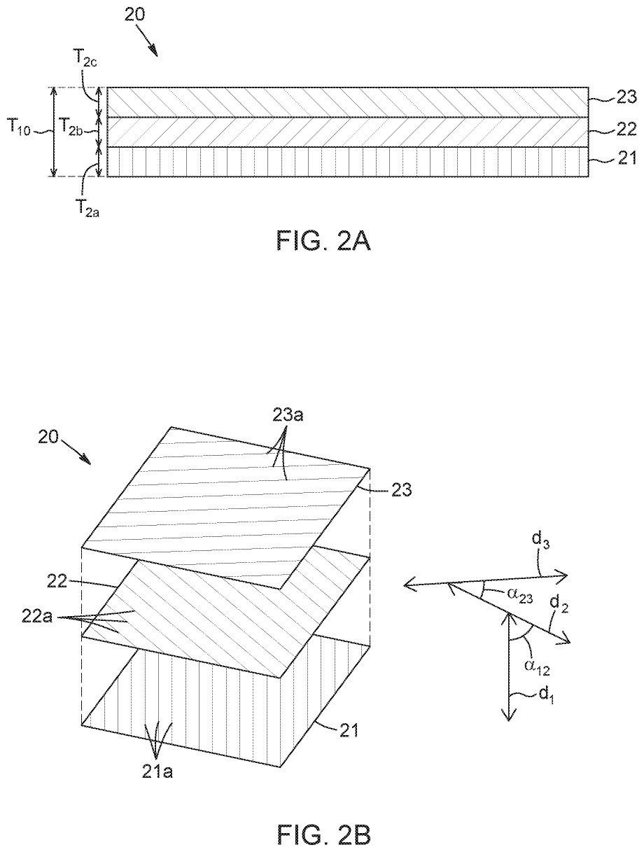

As illustrated on FIGS. 2A and 2B, an X-ray window 20 including three unidirectional carbon fiber sheets 21, 22 and 23 is shown. Carbon fiber sheet 22 is stacked over carbon fiber sheet 21, and carbon fiber sheet 23 is stacked over carbon fiber sheet 22. Carbon fiber sheets 21, 22 and 23 are bound together. In the cross-section view shown at FIG. 2A, carbon fiber sheets 21, 22 and 23 have a thickness T₂ₐ, T_{2b} and T_{2c}, respectively, that can vary. For example, the thickness of each carbon fiber sheet can be between 0.1 mm and 0.3 mm. consequently, the total thickness T₁₀ of the X-ray window 10 can also vary. For example, the thickness T₁₀ can be between about 0.3 mm and about 1 mm. In the unstacked view shown at FIG. 2B, the carbon fiber sheets 21, 22 and 23 are shown individually. Carbon fiber sheet 21 includes carbon fibers 21a that are oriented substantially in one direction d₁. Similarly, carbon fiber sheet 22 includes carbon fibers 22a that are oriented substantially in one direction d₂, with d₂ being at an angle α₁₂ relative to d₁. Similarly, carbon fiber sheet 23 includes carbon fibers 23a that are oriented substantially in one direction d₃, with d₃ being at an angle α₂₃ relative to d₂. On FIG. 2B, the angle α₁₂ is of about 45° and the angle α₂₃ is of about 30°. However, it should be understood that the angles α₁₂ and α₂₃ can vary, for example to each be independently between about 5 and 175° or between about 30° and about 110°, or between about 45° and about 90°.

It should be understood that the number of carbon fiber sheets that can be stacked over one another are not limited to 2 or 3, as shown in the exemplified embodiments of FIGS. 1A and 2A. In some implementations, the X-ray window can include 4, 5, 6 or more carbon fiber sheets of various thicknesses, so long that at least part of the X-ray radiation is still able to go through the carbon fiber sheet and allow performing X-ray measurements. In some implementations, the angle between the carbon fibers of any given carbon fiber sheet and the carbon fibers of an adjacent carbon fiber sheet can be between about 5° and 175° or between about 30° and about 110°, or between about 45 and about 90°.

In some scenarios, the angle is of about 45 or about 90°. In some scenarios, the X-ray window can be provided in a quasi-isotropic configuration, wherein the carbon fibers of each carbon fiber sheet are oriented at an angle of about 45 with reference to the carbon fibers of an adjacent carbon fiber sheet upon which it is stacked. It should be understood that when the term “quasi-isotropic configuration” is used, with angles of “about 45°” between neighboring carbon fiber sheets, it is understood that the relative angle of each sheet with respect to a neighboring sheet can vary between 40° and 50° (i.e., account to an error factor on the “about 45°” angle). All the relative angles between the sheets of a same window are therefore not necessarily equal so long as each relative angle is of about 45°.

In some scenarios, the X-ray window can be provided in a bi-directional configuration, wherein the carbon fibers of each carbon fiber sheet are oriented at an angle of about 90° with reference to the carbon fibers of an adjacent carbon fiber sheet upon which it is stacked. It should be understood that when the term “bi-directional configuration” is used, with angles of “about 90°” between neighboring carbon fiber sheets, it is understood that the relative angle of each sheet with respect to a neighboring sheet can vary between 80° and 100°, or between 85° and 95° (i.e., account to an error factor on the “about 90°” angle). All the relative angles between the sheets of a same window are therefore not necessarily equal so long as each relative angle is of about 90°.

In some embodiments the X-ray window includes at least one woven carbon fiber sheet, such as a carbon fiber twill weave. In some scenarios, the carbon fiber twill weave can be a 2×2 twill weave. It should be understood that at least one woven carbon fiber sheet can include a single woven carbon fiber sheet, or a plurality of woven carbon fiber sheets stacked upon one another. It should also be understood that the X-ray window can include at least one woven carbon fiber sheet and at least one unidirectional carbon fiber sheet.

The X-ray window can include a binding material that binds the carbon fiber sheets together, the binding material being at least partially transparent to X-ray radiation. In some embodiments, the binding material can include at least one of a thermosetting polymer and a thermoplastic polymer. For example, the thermosetting polymer can include an epoxy resin and the thermoplastic polymer can include a polyimide. It should be understood that certain binding materials can be classified as both a thermoplastic polymer (before curing) and a thermosetting polymer (after curing), such as certain types of polyimides. It is understood that other types of binding materials can be used to achieve desired properties of the carbon fiber window. For example, phenol resins may be used for certain applications such as high temperature applications.

In some embodiments, the X-ray window can further include at least one layer of non-carbon fiber material that is at least partially transparent to X-ray radiation. For example, the non-carbon fiber material can include at least one of beryllium, a polymer (e.g., a polyimide such as Kapton™), diamond, graphene, diamond-like carbon, carbon nanotubes, and combinations thereof. In some embodiments, a layer of non-carbon fiber material can be stacked over and/or under the carbon fiber sheets. In other embodiments, a layer of non-carbon fiber material can be can be embedded in at least one of the carbon fiber sheets. In yet another embodiment, a layer of non-carbon fiber material can be stacked between two adjacent carbon fiber sheets.

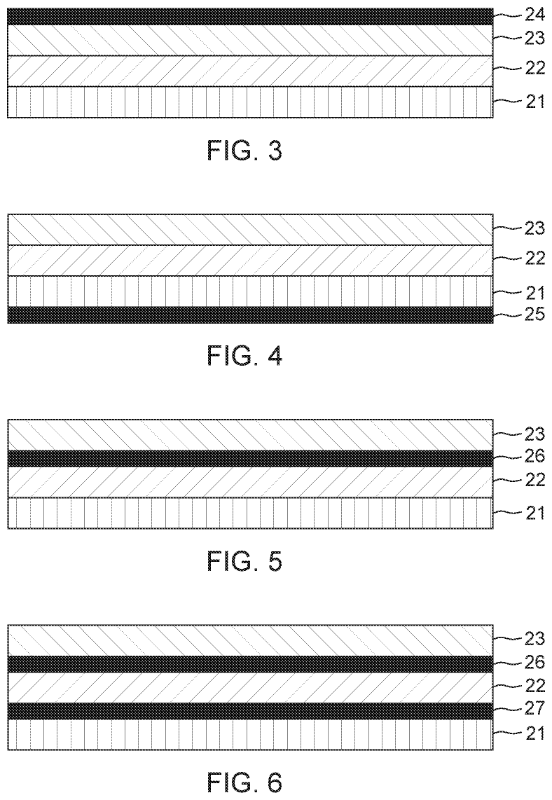

FIGS. 3 to 6 show various non-limiting examples of X-ray windows that include three unidirectional carbon fiber sheets and at least one non-carbon fiber layer. In the example shown on FIG. 3, a non-carbon fiber layer 24 can be positioned at the top of the X-ray window, such that the non-carbon fiber layer 24 is stacked over carbon fiber sheet 23, and can be the first layer to be contacted by X-ray radiation upon irradiation of the X-ray diffraction chamber. In another example, as shown on FIG. 4, a non-carbon fiber layer 25 can be positioned at the bottom of the X-ray window, such that carbon fiber sheet 21 is stacked over the non-carbon fiber layer 25. In this configuration, the non-carbon fiber layer 25 can be the last layer of the X-ray window to be in contact with X-ray radiation upon irradiation of the X-ray diffraction chamber. In another example, as shown on FIG. 5, a non-carbon fiber layer 26 can be stacked between two adjacent carbon fiber sheets 22, 23. In yet another example, as shown on FIG. 6, non-carbon fiber layers 26, 27 can be stacked between two adjacent carbon fiber sheets 22, 23 and 21, 22, respectively.

The carbon fiber content of the X-ray window can vary depending on the type of materials used in the X-ray window and/or the type of measurement performed, and/or the type of application. In some embodiments, the X-ray window can have a carbon fiber content of at least 40 wt %, or at least 50 wt %, or at least 60 wt %, or at least 70 wt %. In some embodiments, the carbon fiber content is between about 50 wt % and about 70 wt %, and the binding material content is between about 30 wt % and about 50 wt %. In some embodiments, the carbon fiber content is between 50 wt % and 70 wt %, with the remainder being the binding material. In some embodiments, the X-ray window can have a carbon fiber content of at least 40 vol %, or at least 50 vol %, or at least 60 vol %, or at least 70 vol %. In some embodiments, the carbon fiber content is between about 50 vol % and about 70 vol %, and the binding material content is between about 30 vol % and about 50 vol %. In some embodiments, the carbon fiber content is between 50 vol % and 70 vol %, with the remainder being the binding material.

By selecting appropriate X-ray panel thickness, composition, size and/or configuration of layers, the X-ray window can be adapted to attenuate a certain percentage of an X-ray radiation such as Cu, Mo and/or Ag X-ray radiation. In some scenarios, the X-ray panel can be adapted to attenuate 80% or less, or 60% or less, or 40% or less of Cu X-ray radiations. In some scenarios, the X-ray panel can be adapted to attenuate 80% or less, or 60% or less, or 40% or less, or 20% or less of Mo X-ray radiations. In some scenarios, the X-ray panel can be adapted to attenuate 80% or less, or 60% or less, or 40% or less, or 20% or less of Ag X-ray radiations.

### X-Ray Diffraction Chamber

The present description also provides an X-ray diffraction chamber for an X-ray diffractometer, that can include one or more of the X-ray windows described herein. In some embodiments, the X-ray diffraction chamber can be adapted for operation at pressures higher than atmospheric pressure, such as 2 atm or greater, or for vacuum pressure applications, such as lower than 1 atm. In some embodiments, the X-ray diffraction chamber can be adapted for operation at various temperatures, humidity levels, and/or types of atmospheres (including measurements under vacuum). In some scenarios, the X-ray diffraction chamber can be used as a heating stage or to perform temperature probing. Depending on the configuration of the X-ray window (e.g., surface area, length, width of the X-ray window, configuration of the X-ray window support members, configuration of the securing plate), the X-ray diffraction chamber can be adapted to collect X-ray diffraction data at various 2θ angles. In some implementations, the range of 2θ angles can be between about 0.1° and 179°, or between about 0.1° and about 48°, or between about 10° and about 56°, or between about 2° and about 70°. It should be noted that the mentioned ranged are non-limiting and may vary.

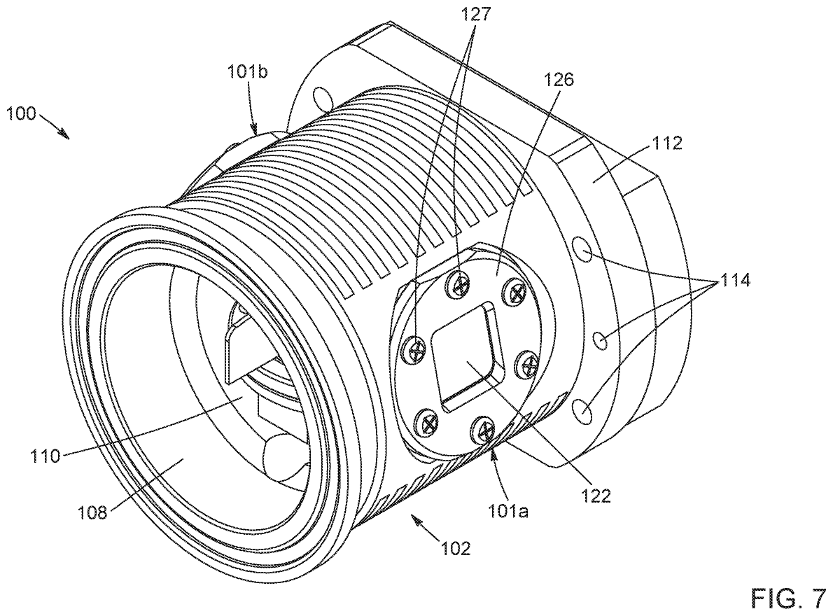

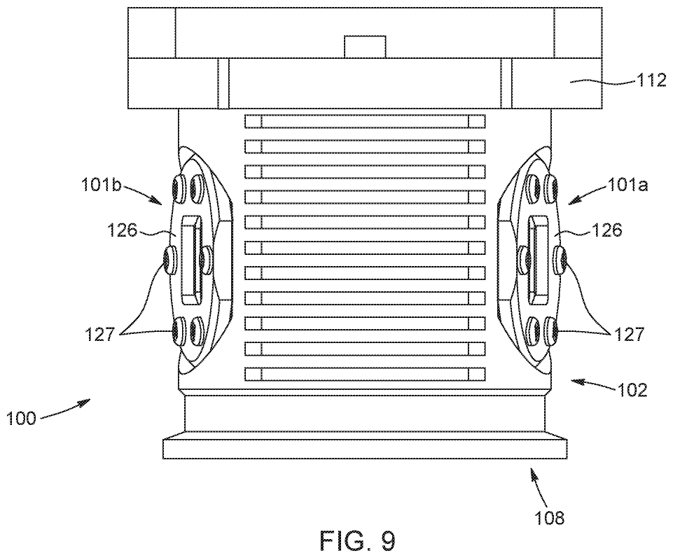

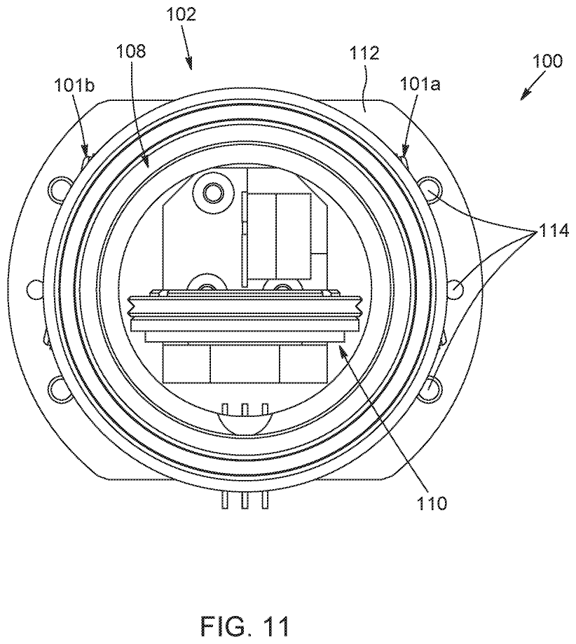

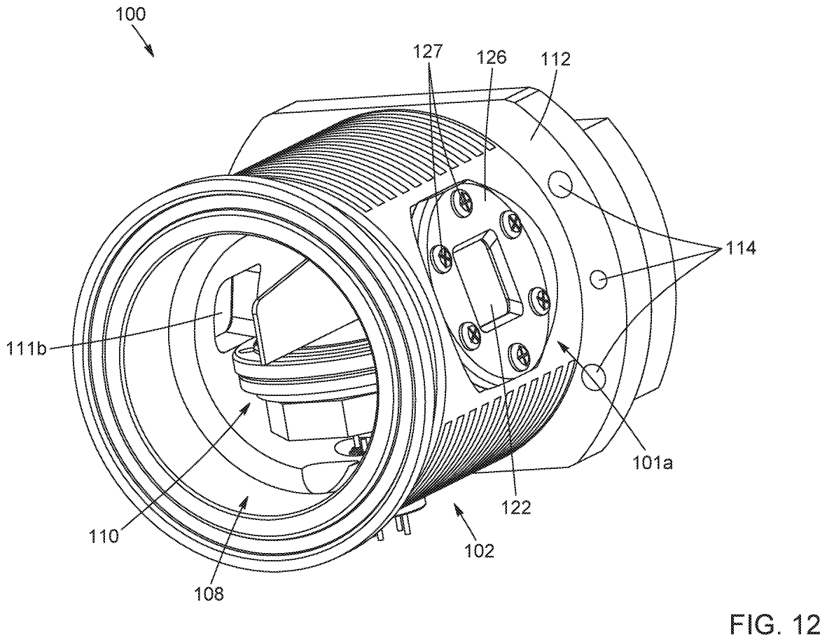

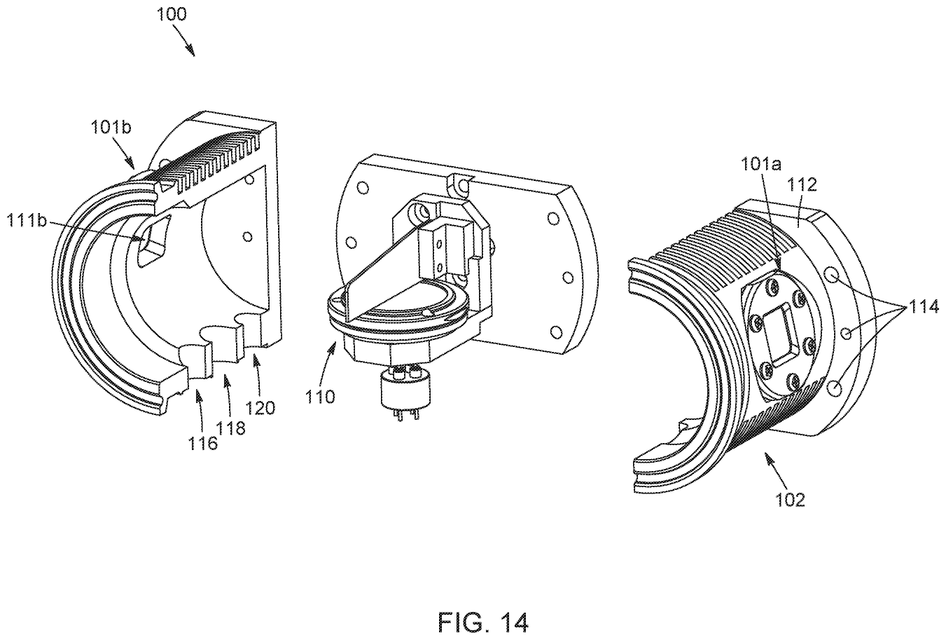

Referring to FIGS. 7 to 14, an X-ray diffraction chamber 100 according to an embodiment of the present description is shown. The X-ray diffraction chamber 100 includes a housing 102, a first X-ray window assembly 101a provided on an input side of the housing 102, and a second X-ray window assembly 101b provided on an output side of the housing 102. The housing 102 can be reinforced and/or hermetically sealed to enable X-ray diffraction measurements at various temperatures, humidity levels, and/or types of atmospheres (including measurements under vacuum). At least one of the X-ray window assemblies 101a, 101b can include a carbon-fiber X-ray window of the present description. The X-ray diffraction chamber 100, housing 102 and X-ray window assemblies 101a, 101b can also include other components, as will be described in further detail herein.

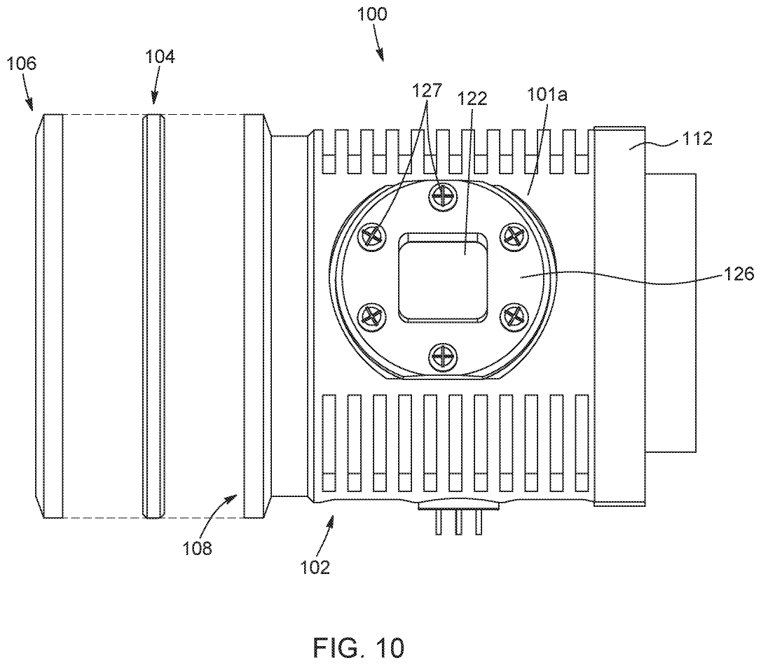

As best seen in FIG. 10, the X-ray diffraction chamber 100 can optionally include gasket 104 and covering plate 106, to cover and seal insertion hole 108, the gasket 104 and covering plate 106 not being shown for clarity purposes in FIGS. 1-9 and 10-14. The insertion hole 108 can be used by a user to place testing material onto a sample holder 110 located inside the X-ray diffraction chamber 100, or can be used to configure various elements on the sample holder 110 or inside the housing 102. It should be understood that the combination of the gasket 104 and covering plate 106 is but one possible mean of sealing of the X-ray diffraction chamber 100, and that other configurations for sealing the X-ray diffraction chamber 100 are possible.

Still referring to FIGS. 7 to 14, the housing 102 is provided with input aperture 111a on the input side of the housing 102 and output aperture 111b on the output side of the housing 102, over which the window assemblies 101a, 101b are respectively mounted. It should be understood that the input aperture 111a and output aperture 111b are positioned such that they are optically aligned with each other. In other terms, input and output apertures 111a, 111b are positioned such that incoming X-rays entering the X-ray diffraction chamber 100 via the input aperture 111a are reflected out of the X-ray diffraction chamber 100 via the output aperture 111b.

The housing 102 can also be provided with abase 112 that can be used to affix the X-ray diffraction chamber 100 to the body of the X-ray diffraction apparatus. In the embodiment shown on the Figures, the base 112 is provided with holes 114 through which a fastener can be threaded to fasten the X-ray diffraction chamber 100 to the X-ray diffraction apparatus. It should be understood that the base 112 can be affixed to the X-ray diffraction apparatus by other means.

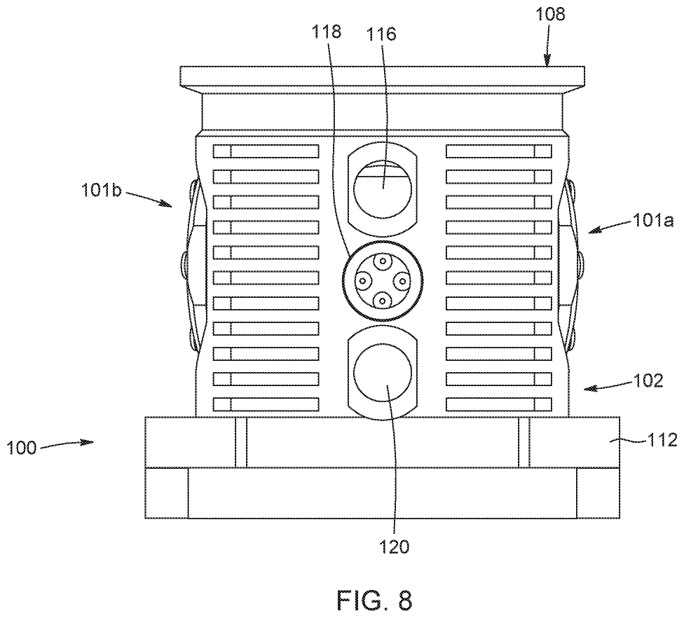

As best seen on FIG. 8, the X-ray diffraction chamber 100 can include several feed-through holes 116, 118, 120 that can be used to provide pressurizing gas, vacuum, electrical connections, a gas other than air (such as hydrogen, carbon dioxide, nitrogen, argon, oxygen etc.) inside the X-ray diffraction chamber 100. In the embodiment shown, only feed-through hole 118 is provided with a feed-through line.

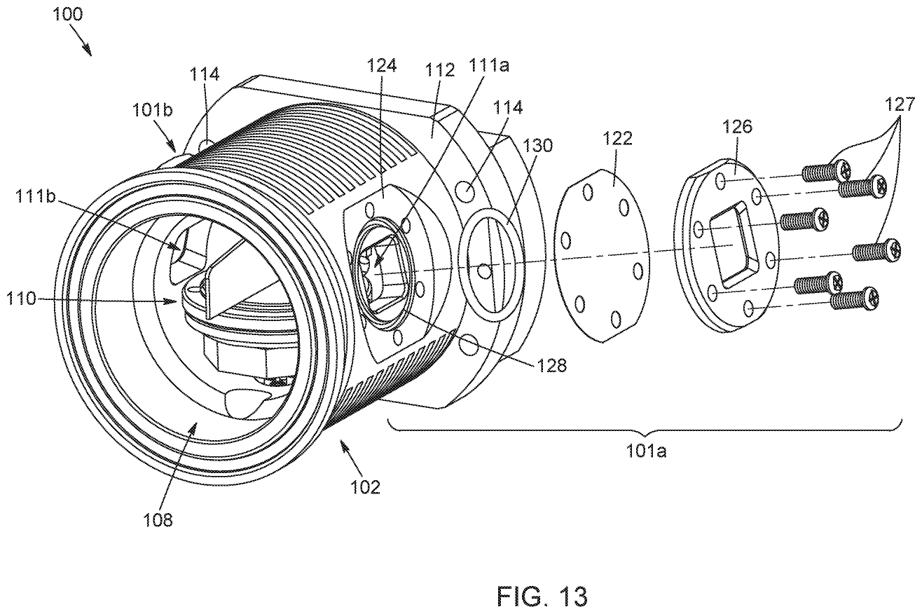

The X-ray window assembly 101a, 101b includes at least an X-ray window and means of affixing the X-ray window to the housing 102. In the embodiment shown on the Figures, and as best seen on FIG. 13, X-ray window assembly 101a includes X-ray window 122, that is abutted on support surface 124 defined in the housing 102. The X-ray window 122 is positioned over the aperture 111a such that X-ray radiation can pass therethrough. A securing plate 126 is positioned over the X-ray window 122, such that the X-ray window 122 is sandwiched between the securing plate 126 and the support surface 124. In the embodiment shown, the support surface 124, X-ray window 122 and securing plate 126 are provided with a series of holes to allow for fasteners (e.g., screws 127 in the embodiment shown) to hold the X-ray window assembly 101a together.

The support surface 124 can also be provided with sealing hole 128 into which a sealing element 130 such as a gasket or an O-ring can be inserted. The sealing element 130 can allow to seal the contact area between the X-ray window 122 and the support surface 124.

In some embodiments, the securing plate 126 covers at least a certain portion of the X-ray window 101a, 101b, in order to relieve pressure force from the X-ray window and transfer at least part of the pressure forces to the securing plate 126. For example, the securing plate 126 can cover at least 20%, 30%, 40%, 50%, 60%, 70%, 80% or more of the surface area of the X-ray window 101a, 101b. Preferably, the securing plate 126 covers a portion of the X-ray window 101a, 101b starting from a periphery of the X-ray window 101a, 101b, such that a central portion of the X-ray window 101a, 101b is positioned over the aperture 111a, 111b and clear of the securing plate 126 such that X-ray radiation can pass through the first X-ray window 101a, penetrate the X-ray diffraction chamber 100 and be reflected out through the second X-ray window 101b.

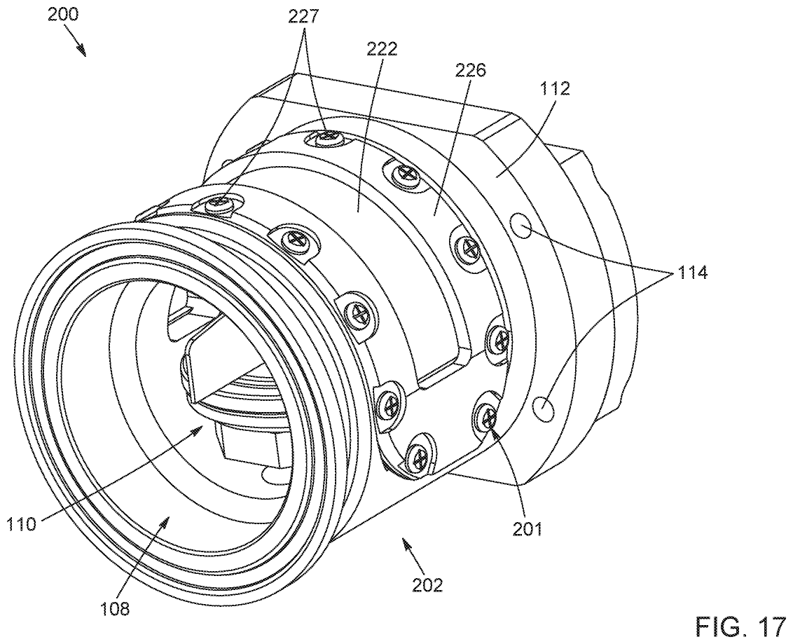

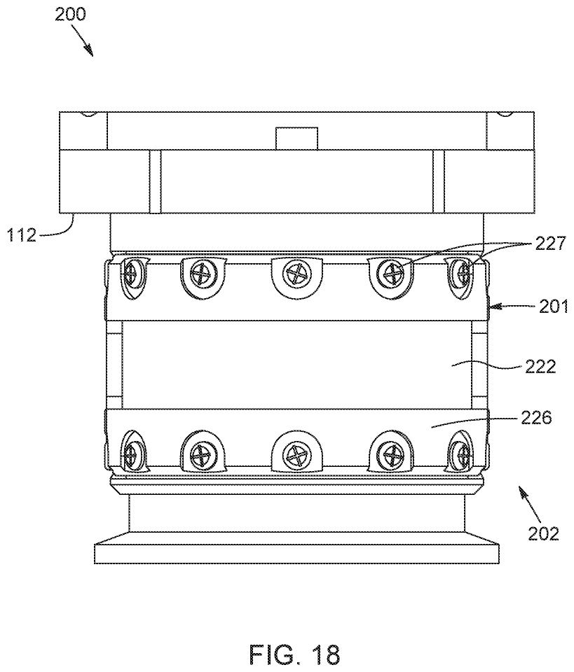

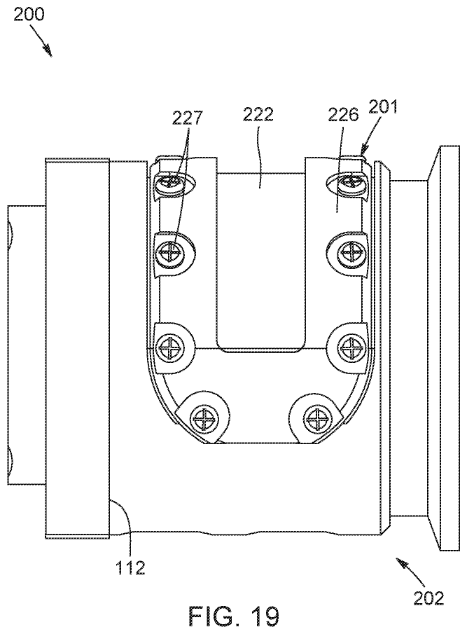

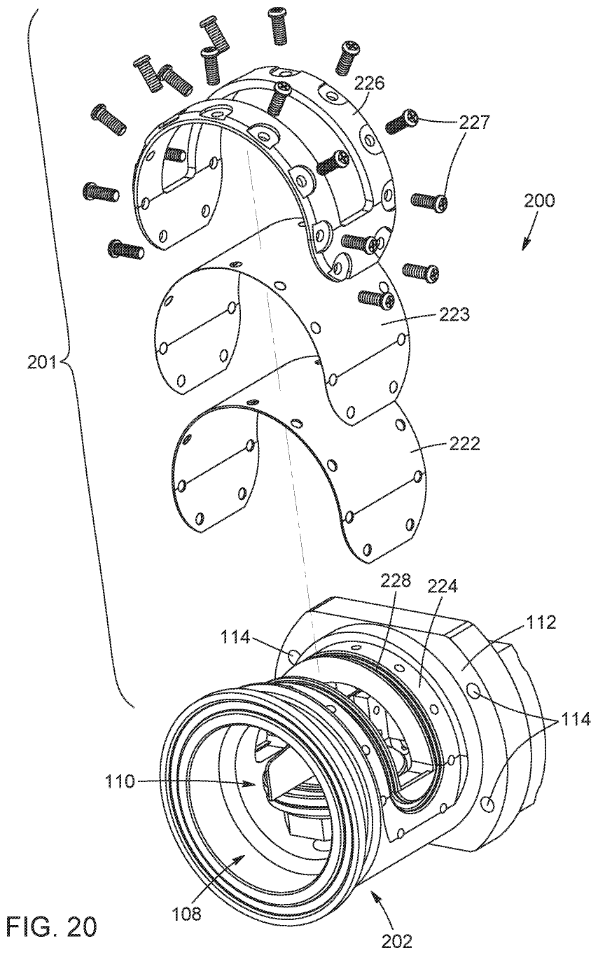

Now referring to FIGS. 17 to 20, an X-ray diffraction chamber according to another embodiment of the present description is shown. The X-ray diffraction chamber 100 includes a housing 202, and an X-ray window assembly 201 spanning from an input side of the housing 202 to an output side of the housing 102. The housing 202 can be reinforced and/or hermetically sealed to enable X-ray diffraction measurements at various temperatures, humidity levels, and/or types of atmospheres (including measurements under vacuum). The X-ray window assembly 201 can include a carbon-fiber X-ray window of the present description. The X-ray diffraction chamber 200, housing 202 and X-ray window assembly 201 can also include other components, as will be described in further detail herein.

In the embodiment shown, the support surface 224, X-ray window 222 and securing plate 226 are provided with a series of holes to allow for fasteners (e.g., screws 227 in the embodiment shown) to hold the X-ray window assembly 201 together.

The X-ray diffraction chamber 200 includes a carbon fiber window 222 that fits the outer circular shape of the X-ray diffraction chamber 200. In the embodiment shown, the X-ray window 222 is bent in a half-circle-like shape spanning from an input side of the housing 202 of the X-ray diffraction chamber 222 to an output side of the housing 202 of the X-ray diffraction chamber 222. As better shown in FIG. 20, the carbon fiber window 222 is sandwiched between securing plate 226 and support surface 224. It should be understood that the shape of the carbon fiber window can vary and can be configured in any suitable shape. The support surface 224 can also be provided with sealing hole 228 into which a sealing element (not shown) similar to sealing element 130 (such as a gasket or an O-ring) can be inserted. The sealing element can allow to seal the contact area between the X-ray window 222 and the support surface 224. In the embodiment shown, an optional protective layer 223 of thin polyimide (Kapton™) is provided between the X-ray window 222 and the securing plate 226. The protective layer 223 can provide chemical protection to the carbon fiber window 222, that is protection from external chemical components that may contaminate the carbon fiber window 222.

It should be understood that various changes can be made to the X-ray window assembly. For example, several elements can be changed or vary, such as but not limited to the size, shape, and/or type of X-ray window, the type of fastener used to hold the X-ray window assembly together, the size, shape, thickness and/or type of securing plate. For example, the X-ray window can be a hemisphere window, that can withstand pressures above atmospheric pressure, such as up to 10 bars.

### EXAMPLES

### Example 1: Material Burst Pressure Test

Experiments were conducted to evaluate the burst pressure of several carbon fiber-based window films, compared to a Kapton™ window film. The following steps were performed to prepare for and conduct the experiments:
1. using a vessel made from an aluminum block, an oval hole (having dimensions 20 mm wide×12 mm tall) was cut through the entirety of the block; this hole constituted the volume chamber.
2. A groove for a standard size O-ring (ø28 mm, 2 mm thickness) was made evenly around the oval hole and the O-ring placed inside it; the compression of the O-ring will form the air-tight seal required to retain pressure in the chamber.
3. An oval pattern of 12 (twelve) threaded holes was distributed evenly around the O-ring; these threaded holes will be used for securely holding the materials in place (see point 7 below).
4. A threaded hole was drilled in the aluminum block in a direction perpendicular to the oval hole, such that that two holes were connected; this second hole is used for introducing gas to the system.
5. The material to be tested was cut into two rectangles of dimensions 50 mm by 45 mm and 12 (twelve) M3 holes were drilled in a pattern matching that described in 3 above.
6. Securing plates were made out of a sheet of stainless-steel cut into a rectangle having dimensions 50 mm by 45 mm by 3 mm, having 12 (twelve) M3 holes drilled in a pattern matching that described in 3 above, and an oval hole matching that in 1.
7. The material to be tested was placed in between the aluminum block 1 and securing plates 6 and secured tightly by 12 (twelve) M3 screws.
8. The chamber was connected to an N₂ gas cylinder (pressurized to ca. 2200 psi) by means of Swagelok® connectors and hoses attached to the threaded hole described in 4.
9. The pressure of the system was monitored by a pressure gauge attached to the gas cylinder having pressure gradations of 100 psi.
10. The entire system (hoses from the gas cylinder and the assembled test chamber 7) was pressurized until the material failed (evidenced by tearing/breaking/cracking of the material and a subsequent release of the pressure to atmosphere).

The results are summarized in Table 1 below:

TABLE 1
measurement of plastic deformation pressure
and burst pressure for several window films

| | Pressure in PSI (lbs · in⁻²) | |
|---|---|---|
| | Plastic | Burst |
| Window material | deformation | pressure |
| Comparative: Kapton ™ window film | 150 | 450 |
| (500PST, 0.15 mm thickness) | | |
| 0.38 mm laminated carbon fiber sheet | 150 | 650 |
| (0.08 mm Polyethylene terephthalate | | |
| (PET) laminating material and 0.3 | | |
| mm carbon fiber panel) | | |
| 0.3 mm carbon fiber sheet - 3k thread | N/A | 450 |
| count - 2 × 2 twill weave | | |
| 0.5 mm carbon fiber sheet - 6k thread | N/A | 650 |
| count - 2 × 2 twill weave | | |
| 0.8 mm carbon fiber sheet - three (3) | N/A | 1800 |
| unidirectional carbon fiber layers in a | | |
| quasi isotropic configuration (i.e., | | |
| each layer has a 45° angle compared to | | |
| adjacent(s) layer(s)) - 6k thread count | | |

It was shown that the 0.8 mm carbon fiber sheet made of multiple unidirectional carbon fiber layers was able to withstand a far greater pressure compared to the comparative Kapton™ window and compared to the 0.3 mm and 0.5 mm carbon fiber sheets.

### Example 2: X-Ray Attenuation Tests with Cu Source (λ=1.541 Å)

Experiments were conducted to evaluate X-ray attenuation with window films made of different materials, when using a copper source.

The cell body was aligned in an X-ray diffractometer according to standard practice (i.e., centering the sample in the beam path, adjusting beam alignment, and referencing zero position), diffraction patterns for a sample of LaB₆ were obtained in Bragg-Brentano geometry in the 20 range of 10−60° and using Cu radiation.

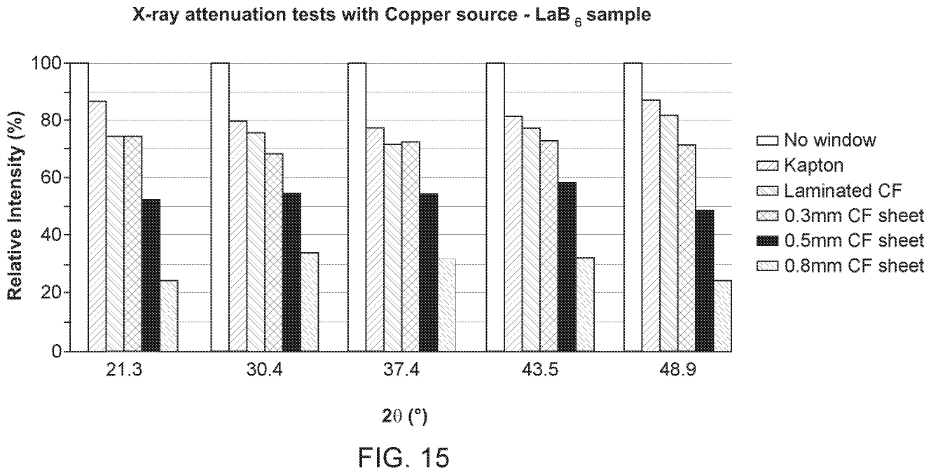

Five diffraction peaks are present for LaB₆ in this 2θ range. The window film materials were changed in between measurements, from no material (100% intensity reference) to Kapton™, to different thicknesses and types of carbon fiber materials. The results are summarized in FIG. 15 for the five observable peaks of LaB₆.

FIG. 15 is a graph showing the Relative diffraction peak intensity for LaB₆, as a function of window film materials when collected using Cu radiation. The peak intensity dropped off as the thickness of the material increased. The decrease in integrated peak intensity relative to the reference was (averaged over the observable peaks): 18% for Kapton™, 25% for laminated CF, 29% for 0.3 mm CF sheet, 47% for 0.5 mm CF sheet, and 72% for 0.8 mm CF sheet.

While all the CF sheets exhibited a greater attenuation than the comparative Kapton™ window when using a copper source, the attenuation still allowed for conducting X-ray measurements. One can simply run the X-ray diffraction experiment for a longer time period to arrive at the same signal intensity.

### Example 3: X-Ray Attenuation Tests with Mo Source (λ=0.709 \acute{Å})

Experiments were conducted to evaluate X-ray attenuation with window films made of different materials, when using a molybdenum source.

The cell body was aligned in an X-ray diffractometer according to standard practice (i.e., centering the sample in the beam path, adjusting beam alignment, and referencing zero position), diffraction patterns for a sample of LaB₆ were obtained in Bragg-Brentano geometry in the 20 range of 7−33° and using Mo radiation.

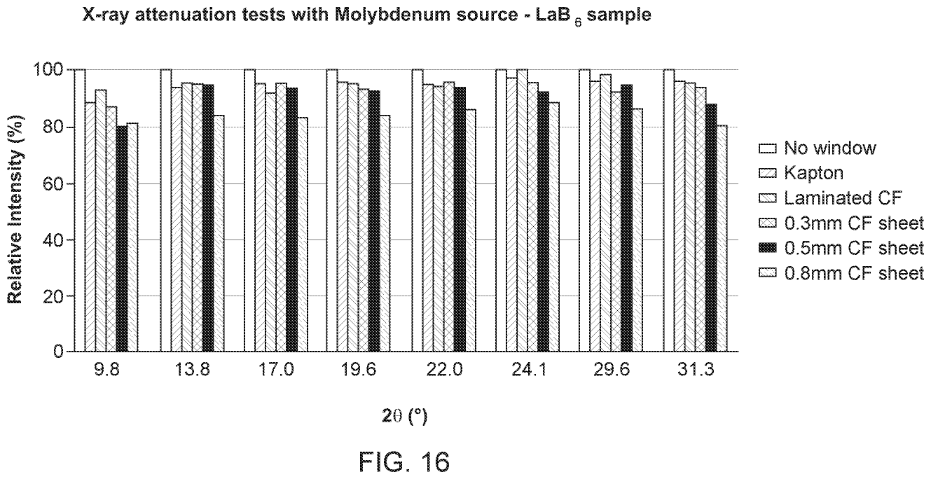

Eight diffraction peaks are present for LaB₆ in this 20 range. Following the same procedure as for the tests using Cu radiation above, the window materials were changed in between measurements, from no material (100% intensity reference) to Kapton™, to different thicknesses and types of carbon fiber materials. The results are summarized in FIG. 16 for the eight observable diffraction peaks of LaB₆.

FIG. 16 is a graph showing the relative diffraction peak intensity for LaB₆, as a function of window materials when collected using Mo radiation. The peak intensity is reduced as the thickness of the material increases. The decrease in integrated peak intensity relative to the reference is (averaged over the observable peaks): 94% for Kapton™, 94% for laminated CF, 93% for 0.3 mm CF sheet, 91% for 0.5 mm CF sheet, and 83% for 0.8 mm CF sheet.

All the CF sheets exhibited a slightly increased attenuation than the comparative Kapton™ window when using a molybdenum source. The small attenuation allowed conducting X-ray measurements with little effect on the intensity. One can simply run the X-ray diffraction experiment for a slightly longer time period to arrive at the same signal intensity.

What is claimed is:

1. An X-ray window of an X-ray diffractometer diffraction chamber, the X-ray window comprising a plurality of unidirectional carbon fiber sheets stacked one over another and bound together, wherein carbon fibers in adjacent carbon fiber sheets are disposed at an angle relative to one another.

2. The X-ray window of claim 1, that is adapted for use at a pressure greater than atmospheric pressure.

3. The X-ray window of claim 1, that is adapted for use at atmospheric pressure or at a pressure lower than atmospheric pressure.

4. The X-ray window of claim 1, wherein the plurality of unidirectional carbon fiber sheets comprises:
a first carbon fiber sheet comprising carbon fibers oriented in a first direction; and
a second carbon fiber sheet stacked over the first carbon fiber sheet, the second carbon fiber sheet comprising carbon fibers oriented in a second direction at an angle α₁₋₂ between about 5° and about 175° relative to the first direction.

5. The X-ray window of claim 4, wherein the plurality of unidirectional carbon fiber sheets further comprises:
a third carbon fiber sheet stacked over the second carbon fiber sheet, the third carbon fiber sheet comprising carbon fibers oriented in a third direction at an angle α₂₋₃ between about 5° and about 175° relative to the second direction.

6. The X-ray window of claim 1, wherein each of the unidirectional carbon fiber sheets is independently oriented at an angle of about 45° or about 90° relative to adjacent unidirectional carbon fiber sheets.

7. The X-ray window of claim 1, further comprising a binding material that binds the plurality of unidirectional carbon fiber sheets together, the binding material being at least partially transparent to X-ray radiation.

8. The X-ray window of claim 7, wherein the binding material comprises at least one of a thermosetting polymer and a thermoplastic polymer.

9. The X-ray window of claim 1, further comprising at least one layer of non-carbon fiber material that is at least partially transparent to X-ray radiation.

10. The X-ray window of claim 7, having a carbon fiber content between 50 wt % and 70 wt %, and a binding material content between about 50 wt % and about 30 wt %.

11. An X-ray window of an X-ray diffractometer diffraction chamber, the X-ray window comprising at least one carbon fiber sheet, the X-ray window having a carbon fiber content of at least 50 wt % and a thickness between about 0.2 mm and about 5 mm to be adapted for use at a pressure greater than atmospheric pressure.

12. The X-ray window of claim 11, wherein the pressure is of about 2 atm or greater.

13. The X-ray window of claim 11, wherein the at least one carbon fiber sheet comprises a plurality of unidirectional carbon fiber sheets stacked one over another, wherein carbon fibers in adjacent carbon fiber sheets are disposed at an angle relative to one another.

14. The X-ray window of claim 13, wherein the plurality of unidirectional carbon fiber sheets comprises:
a first carbon fiber sheet comprising carbon fibers oriented in a first direction; and
a second carbon fiber sheet stacked over the first carbon fiber sheet, the second carbon fiber sheet comprising carbon fibers oriented in a second direction at an angle α₁₋₂ between about 5° and about 175° relative to the first direction.

15. The X-ray window of claim 13, wherein each of the unidirectional carbon fiber sheets is independently oriented at an angle of about 45° or about 90° relative to adjacent unidirectional carbon fiber sheets.

16. The X-ray window of claim 11, further comprising at least one layer of non-carbon fiber material that is at least partially transparent to X-ray radiation.

17. The X-ray window of claim 16, wherein the non-carbon fiber material comprises at least one of beryllium, a polymer, diamond, graphene, diamond-like carbon, carbon nanotubes, and combinations thereof.

18. The X-ray window of claim 17, wherein the polymer comprises a polyimide.

19. The X-ray window of claim 16, wherein the at least one layer of non-carbon fiber material is stacked over or under the plurality of unidirectional carbon fiber sheets.

20. The X-ray window of claim 16, wherein the at least one layer of non-carbon fiber material comprises two layers of non-carbon fiber material sandwiching the plurality of unidirectional carbon fiber sheets.
